(19) United States
(12) Patent Application Publication
(10) Pub. No.: US 2021/0141974 A1
(43) Pub. Date: May 13, 2021

(54) METHOD FOR DETERMINING THE OUTPUT PHYSICAL QUANTITY OF A SYSTEM AND ASSOCIATED CONTROL METHOD

(71) Applicant: Commissariat à l'énergie atomique et aux énergies alternatives, PARIS (FR)

(72) Inventors: Hervé GUILLOU, GRENOBLE CEDEX 09 (FR); Yacine GAOUA, GRENOBLE CEDEX 09 (FR)

(21) Appl. No.: 17/097,646

(22) Filed: Nov. 13, 2020

(30) Foreign Application Priority Data
Nov. 13, 2019 (FR) 1912672

(51) Int. Cl. G06F 30/20

(52) U.S. Cl. CPC G06F 30/20; G06F 2111/10

(57) ABSTRACT

A method for determining the output physical quantity Y of a system from an input physical quantity X of the system and a non-linear convex physical model of the system associating with an input physical quantity x̅ᵢ an output physical quantity y̅ᵢ, the method including determining, using the non-linear physical model, a plurality of operating points M̅ᵢ of coordinates (x̅ᵢ, y̅ᵢ) with i ∈ [1, N]; determining an optimal vector U^{opt} among a plurality of vectors U^{j}, the vectors U^{j} including N coordinates uᵢ^{j} ∈ [0,1], the constraints on the coordinates being:

$$\{ \begin{matrix}X = {\sum }_{i = 1}^{N} {\overline{x}}_{i} \times {u}_{i}^{j} \\ {\sum }_{i = 1}^{N} {u}_{i}^{j} = 1\end{matrix} ,$$

the optimal vector U^{opt} being associated with the following lowest objective function: M×Σᵢ₌₁^{N}y̅ᵢ×uᵢ^{j} where M is a weighting coefficient strictly greater than zero; and determining the output physical quantity Y given by:

Y=Σᵢ₌₁^{N}y̅ᵢ×uᵢ^{opt}.

### CROSS REFERENCES TO RELATED APPLICATIONS

This application claims priority to French Patent Application No. 1912672, filed Nov. 13, 2019, the entire content of which is incorporated herein by reference in its entirety.

### FIELD

The technical field of the invention is that of the linearization of physical models and the control of installations, for example electrical installations.

The present invention relates to a method for determining the output physical quantity of a system from an input physical quantity and a non-linear model of the system. It also proposes a control method using such a method for determining the output physical quantity of a system.

### BACKGROUND

In order to manage a multi-energy networked system efficiently, it is vital to equip the system with a smart control device to meet the expectations of the manager of the network/system who seeks at one and the same time economic efficiency, reduction in environmental impact and multi-energy management. Indeed, the implementation of such a smart control via a so-called predictive command makes it possible to manage, in an optimal manner, the operation of energy sources over an anticipation horizon, as a function of demand and production forecasts for intermittent sources (PV, wind, etc.). It necessitates however the development of an optimization model reflecting the operation of the multi-energy system, which assumes a necessary compromise between precision of modelling (thus, quality of the predictive command) and computing time.

Indeed, the precise modelling of the multi-energy system makes it possible to have efficient control (that is to say, the optimal operating trajectories for the energy sources), but necessitates long computing times to determine the optimal trajectories. The use of a precise modelling is thus compatible with difficulty with deployment in the field for control in real time. Conversely, reduced modelling of the multi-energy system leads to a low performance control (that is to say sub-optimal trajectories) but with reduced computing times. The use of reduced modelling is thus compatible with deployment in the field for control in real time.

In order to reduce computing times, in particular in the case of precise modelling, a known solution is to linearize the models in question, while preserving as much as possible the prediction precision. Such a linearization makes it possible to generate a high level control via the predictive command with reduced computing times for computing the optimal operating trajectories of energy sources.

The linearization methods most widely used in this context are so-called SOS1 for Special Ordered Sets of type 1 and SOS2 for Special Ordered Sets of type 2 techniques.

The SOS1 method is based on a set of variables, of which at the most one variable may take a strictly positive value, all the other variables being equal to 0. This method makes it possible to break down the non-linear function into several linear pieces (or segments). Binary variables are defined so as to specify which of the segments, among the different segments, is used in order to compute the value of any output quantity for any input value. For example, in the case of variable energy losses of a converter as a function of power Pₗₒₛₛ=ƒ(P), for each time t, the SOS1 method makes it possible to choose, as a function of power P(t), the suitable linear segment among the set of linear segments, constituting the non-linear function ƒ(P), to compute the energy losses Pₗₒₛₛ(P) at the time t. To do so, the SOS1 method uses binary variables 0/1 for each time t and for each linear segment of the function ƒ(P) in order to decide which binary variable (that is to say which segment) is used by assigning to it the value 1 and for all the remainder of the binary variables the value 0.

The SOS2 method is based for its part on an ordered set of non-negative variables, of which two variables may take strictly positive values with the condition that these two variables must be consecutive in their order. This method has the advantage of necessitating fewer binary variables than the SOS1 method, which makes it less greedy in computing resources. For example, in the case of energy losses of a converter Pₗₒₛₛ=ƒ(P), the piecewise linearization of the function ƒ via the SOS2 method is written using the following constraints:

$$\{ \begin{matrix}X = {\sum }_{i = 1}^{N} {\overline{x}}_{i} {u}_{i} \\ Y = {\sum }_{i = 1}^{N} {\overline{y}}_{i} {u}_{i} \\ {\sum }_{i = 1}^{N} {u}_{i} = 1 \\ {u}_{i} ∈ S O S 2 , ∀ i ∈ \{ 1 \text{...} N \}\end{matrix}$$

where uᵢ ∈ [0,1], ∀i ∈ {1 . . . N}, y̅ᵢ=ƒ(x̅ₗ̅), X is the value of the power for which it is sought to determine the energy loss value Y. The constraint uᵢ ∈ SOS2, ∀i ∈ {1 . . . N} signifies that only two consecutive coordinates uᵢ may be different from zero.

The two preceding methods have the major drawback of resorting to a high number of binary variables, which makes the computations relatively complex and thus compatible with difficulty with the control in real time of an installation for which it is necessary to compute a set point in a relatively short time (depending on the type of installation).

There thus exists a need for a method making it possible to determine the output value of a non-linear model more efficiently than methods of the prior art.

### SUMMARY

The invention offers a solution to the aforementioned problems, by proposing a method making it possible to minimize, or even eliminate when the model is convex, the use of binary variables.

A first aspect of the invention relates to a method for determining the output physical quantity Y of a system from an input physical quantity X of the system and a non-linear and convex physical model of said system associating with an input physical quantity x̅ᵢ an output physical quantity y̅ₗ̅, the method comprising:
a step of determining, using the non-linear physical model, a plurality of operating points M̅ᵢ of coordinates (x̅ᵢ, y̅ᵢ) with i ∈ [1, N];
a step of determining an optimal vector U^{opt} among a plurality of vectors U^{j}, said vectors U^{j} comprising N coordinates uᵢ^{j} ∈ [0,1], the constraints on said coordinates being:

$$\{ \begin{matrix}X = {\sum }_{i = 1}^{N} {\overline{x}}_{i} \times {u}_{i}^{j} , ∀ j \\ {\sum }_{i = 1}^{N} {u}_{i} = 1 , ∀ j\end{matrix}$$

the optimal vector U^{opt} being associated with the following lowest objective function:

$$M \times {\sum }_{i = 1}^{N} {\overline{y}}_{i} \times {u}_{i}^{j}$$

where M is a weighting coefficient strictly greater than zero;
a step of determining the output physical quantity Y given by:

$$Y = {\sum }_{i = 1}^{N} {\overline{y}}_{i} \times {u}_{i}^{opt}$$

The method according to a first aspect of the invention makes it possible to eliminate the use of binary variables in the form of SOS1 or SOS2 type constraints during the linearization of the model, thus reducing the computing power necessary to perform this linearization. The elimination of binary variables leads to the existence of a plurality of solutions compatible with the imposed constraints among which the optimal solution has to be chosen. To do so, the inventors propose a shrewd use of the convexity of the model through an objective function which makes it possible to determine the optimal solution.

A second aspect of the invention relates to a method for determining the output physical quantity Y of a system from an input physical quantity X of the system and a non-linear and non-convex physical model of the system associating with an input physical quantity x̅ᵢ an output physical quantity y̅ᵢ, the method comprising:
a step of determining, using the non-linear physical model, a plurality of operating points M̅ᵢ of coordinates (x̅ᵢ, y̅ᵢ) with i ∈ [1, N];
a step of determining a plurality of ranges Rₖ of values of x̅ᵢ, the physical model being convex over each of the ranges Rₖ of the plurality of ranges Rₖ thus determined;
a step of determining the range Rᵣ among the plurality of ranges Rₖ such that X ∈ Rᵣ;
a step of determining an optimal vector U^{opt} among a plurality of vectors U^{j}, said vectors U^{j} comprising N coordinates uᵢ^{j} ∈ [0,1], the constraints on said coordinates being:

$$\{ \begin{matrix}X = {\sum }_{{R}_{k}} {\sum }_{i ∈ {R}_{r}} {\overline{x}}_{i} \times {u}_{i}^{j} , ∀ j \\ {\sum }_{i ∈ {R}_{r}} {u}_{i}^{j} = 1 , ∀ j \\ {\sum }_{i ∉ {R}_{r}} {u}_{i}^{j} = 0 , ∀ j\end{matrix}$$

the optimal vector U^{opt} being associated with the following lowest objective function:

$$M \times {\sum }_{{R}_{k}} {\sum }_{i ∈ {R}_{r}} {\overline{y}}_{i} \times {u}_{i}^{j}$$

where M is a weighting coefficient strictly greater than zero;
a step of determining the output physical quantity Y given by:

$$Y = {\sum }_{{R}_{k}} {\sum }_{i ∈ {R}_{r}} {\overline{y}}_{i} \times {u}_{i}^{opt}$$

The method according to a second aspect of the invention makes it possible to limit the use of binary variables to the management of the convex range selected during the linearization of the model, thus reducing the computing power necessary to perform this linearization. The limitation of binary variables to only the management of the selected convex range leads to the existence of a plurality of solutions compatible with the imposed constraints among which the optimal solution has to be chosen. To do so, as in the method according to a first aspect of the invention, the inventors propose a shrewd use of the convexity of the model over the selected convex range through an objective function which makes it possible to determine the optimal solution.

Apart from the characteristics that have been mentioned in the preceding paragraph, the method according to a first or a second aspect of the invention may have one or more complementary characteristics among the following, considered individually or according to all technically possible combinations thereof.

In an embodiment, the method comprises a step of acquiring a plurality of input and output physical quantities of the system so as to determine the physical model of the system. In an embodiment, the number of physical quantities acquired during this step is greater than N.

A third aspect of the invention relates to a method for controlling a system comprising:
a step of determining the temporal evolution of the system, the output physical quantity of the system during this determination being determined using a method according to a first aspect or a second aspect of the invention;
a step of determining a set point, said set point being determined as a function of the temporal evolution of the system determined previously.

A fourth aspect of the invention relates to a computer programme comprising instructions which, when the programme is executed by a computer, lead the computer to implement a method according to a first or a second aspect of the invention.

A fifth aspect of the invention relates to a computer readable data support, on which is recorded the computer programme according to a fourth aspect of the invention.

The invention and the different applications thereof will be better understood on reading the description that follows and by examining the figures that accompany it.

### BRIEF DESCRIPTION OF THE FIGURES

The figures are presented for indicative purposes and in no way limit the invention.

FIG. 1 shows a flow chart of a method according to a first aspect of the invention.

FIG. 2 illustrates a first step of a method according to a first aspect of the invention.

FIG. 3 and FIG. 4 illustrate the consequences of the absence of binary variable on values compatible with the constraints.

FIG. 5 illustrates a second step of a method according to a first aspect of the invention.

FIG. 6 shows a schematic representation of an electrical system modellable by a non-linear model.

FIG. 7 shows a flow chart of a method according to a second aspect of the invention.

FIG. 8 illustrates a non-convex model.

FIG. 9 illustrates the separation of the non-convex model of FIG. 8 into two ranges.

### DETAILED DESCRIPTION

The figures are presented for indicative purposes and in no way limit the invention. Unless stated otherwise, a same element appearing in the different figures has a single reference.

A first aspect of the invention illustrated in FIG. 1 relates to a method 100 for determining the output physical quantity Y of a system from an input physical quantity X of the system and a non-linear and convex physical model of the system associating with an input physical quantity x̅ᵢ an output physical quantity y̅ᵢ. In other words, the method 100 according to a first aspect of the invention makes it possible to determine, from an input physical quantity of a system, an output physical quantity of the system in question, a convex non-linear model of the system being necessary for this determination.

The method 100 according to a first aspect of the invention comprises a step 1E1 of determining, using the non-linear physical model, a plurality of operating points M̅ᵢ of coordinates (x̅ᵢ, y̅ᵢ) with i ∈ [1, N]. This step 1E1 is illustrated in FIG. 2 in which the number of points is equal to 7, the model being represented in the figure by the function ƒ(x) which with a power PAC associates an energy loss PDC. As shown in FIG. 2, the model associated with the function ƒ(x) is non-linear and convex. It will be appreciated that a larger or smaller number of points could be used notably as a function of the degree of non-linearity of the model and/or the desired precision in the determination of the output physical quantity Y.

In an embodiment, the method comprises a step of acquiring a plurality of input and output physical quantities of the system so as to determine the physical model of the system. In other words, during this step, a plurality of experimental points Mₙ of coordinates (xₙ, yₙ) are acquired so as to be able to determine the physical model of the system. The number of points acquired is in an embodiment greater than N (it could also be equal to N, but not less).

The method 100 according to a first aspect of the invention also comprises a step 1E2 of determining an optimal vector U^{opt} among a plurality of vectors U^{j}, the vectors U^{j} comprising N coordinates uᵢ^{j} ∈ [0,1], the constraints on the coordinates being:

$$\{ \begin{matrix}X = {\sum }_{i = 1}^{N} {\overline{x}}_{i} \times {u}_{i}^{j} , ∀ j \\ {\sum }_{i = 1}^{N} {u}_{i}^{j} = 1 , ∀ j\end{matrix}$$

It is important to note here that, in the method 100 according to a first aspect of the invention, the constraints associated with binary variables have disappeared. This comes down to considering a zone represented in “gray” in FIG. 3. In other words, as illustrated in FIG. 4, for a given input physical quantity X, this comes down to envisaging the set of output physical quantities Y situated among the values of the ordinates marked by the straight red line (dotted line at the level of the input physical quantity X considered). In FIG. 4, the highest output physical quantity Y is associated with the vector U=(0.8,0,0,0,0,0,0.2) whereas the lowest output physical quantity Y is associated with the vector U=(0,0.5,0.5,0,0,0,0). It is important however to only select a single vector U^{opt} among the plurality of possible vectors U^{j}, which will be designated optimal vector U^{opt}.

In order to make this selection, the optimal vector is associated with the following lowest objective function:

$$M \times {\sum }_{i = 1}^{N} {\overline{y}}_{i} \times {u}_{i}^{j}$$

where M is a weighting coefficient strictly greater than zero. In other words, one determines the vector U^{opt} making it possible to minimise the preceding objective function. In the example of FIG. 4, the vector U^{opt}=(0,0.5,0.5,0,0,0,0).

Once the optimal vector U^{opt} has been determined, it is possible to determine the output physical quantity. To do so, as illustrated in FIG. 5, the method 100 according to a first aspect of the invention comprises a step 1E3 of determining the output physical quantity Y given by:

$$Y = {\sum }_{i = 1}^{N} {\overline{y}}_{i} \times {u}_{i}^{opt}$$

The method 100 according to an embodiment the invention may for example be used to control a system such as illustrated in FIG. 6. The system in question is composed of photovoltaic panels PV, a storage device ESS and a network grid GRID. In this example, the system is modelled over a horizon of 24 h with a time step of 1 minute and the storage is modelled using the function PDC=ƒ(PAC) described previously. In this model, the storage system ESS contains a non-linear and convex energy losses function which may thus be linearized piecewise. It is thus possible to compare the method 100 according to a first aspect of the invention with the SOS2 method of the prior art. Table 1 hereafter presents the comparative results between these two methods. It may be observed that, for the same solution, the resolution time passes from 2 h for a method according to the prior art to 0.2 seconds for a method 100 according to a first aspect of the invention.

TABLE 1

| | | Method (100) according to |
|---|---|---|
| | | a first aspect of the |
| | SOS2 method | invention |
| Number of continuous | 12960 | 12960 |
| variables | | |
| Number of discrete | 10080 | 0 |
| variables | | |
| Time to compute the | 2 h | 0.2 s |
| optimal solution | | |

It may thus be seen that the elimination of discrete variables has made it possible to improve by several orders of magnitude the time necessary to compute an optimal solution.

The method 100 according to a first aspect of the invention, although benefiting from the elimination of binary variables, does not make it possible on the other hand to treat models which are non-convex. In order to resolve this limitation, a second aspect of the invention illustrated in FIG. 7 relates to a method 200 for determining the output physical quantity Y of a system from an input physical quantity X of the system and a non-linear physical model of said system associating with an input physical quantity x̅ᵢ an output physical quantity y̅ₗ̅.

The method 200 firstly comprises a step 2E1 of determining, using the non-linear physical model, a plurality of operating points M̅ᵢ of coordinates (x̅ᵢ, y̅ᵢ) with i ∈ [1, N]. From these points, it is next possible to identify the ranges over which the model is convex. Range is taken to mean a set of values of the input physical quantity for which the model is convex. In other words, if the model is not convex, it may be considered as being convex by range, that is to say that there exists at least two ranges Rₖ of values of x̅ₗ̅ (in general a plurality of ranges Rₖ) over which the model is convex, the set of ranges Rₖ covering the set of possible values of x̅ₗ̅ (in other words, ∀X, ∃Rₖ such that X ∈ Rₖ). Such a model is illustrated in FIG. 8.

In order to identify these ranges, the method 200 according to a second aspect of the invention comprises a step 2E2 of determining a plurality of ranges Rₖ of values of x̅ᵢ, the physical model being convex over each of the ranges Rₖ of the plurality of ranges Rₖ thus determined. This step 2E2 is illustrated in FIG. 9 in the case where two ranges R₁,R₂ have been identified. Hereafter, for reasons of brevity, when one writes i ∈ Rₖ, this signifies ∀i such that xᵢ ∈ Rₖ.

The method 200 according to a second aspect of the invention next comprises a step 2E3 of determining the range Rᵣ among the plurality of ranges Rₖ such that X ∈ Rᵣ. In the example of FIG. 9, if X is comprised between x₂ and x₃, then the range such that X ∈Rᵣ is the range R₁, that is to say r=1. Once the range of interest has been determined, it is possible of apply the steps of the method 100 according to the first aspect of the invention while taking into account the presence of several ranges Rₖ, a single range Rᵣ being selected at the same time (which thus implies a binary variable by range).

To do so, the method 200 according to a second aspect of the invention comprises a step 2E4 of determining an optimal vector U^{opt} among a plurality of vectors U^{j}, the vectors U^{j} comprising N coordinates uᵢ^{j} ∈ [0,1], the constraints on the coordinates being:

$$\{ \begin{matrix}X = {\sum }_{{R}_{k}} {\sum }_{i ∈ {R}_{r}} {\overline{x}}_{i} \times {u}_{i}^{j} , ∀ j \\ {\sum }_{i ∈ {R}_{r}} {u}_{i}^{j} = 1 , ∀ j \\ {\sum }_{i ∉ {R}_{r}} {u}_{i}^{j} = 0 , ∀ j\end{matrix}$$

The constraints Σ_{i∈R}_{ᵣ} uᵢ^{j}=1 and Σ_{i∉R}_{ᵣ} uᵢ^{j}=0 signify that the coordinates uᵢ^{j} of the vector U^{j} may be non-zero if and only if i ∈ Rᵣ. In the example chosen above, when the chosen range is the range R₁, then only the coordinates u₁, u₂, u₃ and u₄ may be non-zero. This has the consequence that the relationship X=ΣRₖΣ_{i∈R}_{ᵣ}x̅ᵢ×uᵢ^{j} may be rewritten as being X=Σ_{i∈R}_{ᵣ}x̅ᵢ×uᵢ^{j}. One finds here again the formula of the method 100 according to a first aspect of the invention in which only the range Rᵣ has been taken into account.

As detailed previously, it is however important to only select a single vector U^{opt} among the plurality of possible vectors U^{j}, which will be designated optimal vector U^{opt}.

In order to make this selection, the optimal vector U^{opt} is associated with the following lowest objective function:

$$M \times {\sum }_{{R}_{k}} {\sum }_{i ∈ {R}_{r}} {\overline{y}}_{i} \times {u}_{i}^{j}$$

where M is a weighting coefficient strictly greater than zero. Taking account of the constraints Σ_{i∈R}_{ᵣ}uᵢ^{j}=1 and Σ_{i∉R}_{ᵣ}uᵢ^{j}=0, the function may be reformulated in the following manner:

$$M \times {\sum }_{i ∈ {R}_{r}} {\overline{y}}_{i} \times {u}_{i}^{j}$$

One also finds here the objective function of the method 100 according to a first aspect of the invention in which only the range Rᵣ has been taken into account.

Once the optimal vector U^{opt} has been determined, it is possible to determine the output physical quantity Y. To do so, the method 200 according to a second aspect of the invention comprises a step 2E5 of determining the output physical quantity Y given by:

$$Y = {\sum }_{{R}_{k}} {\sum }_{i ∈ {R}_{r}} {\overline{y}}_{i} \times {u}_{i}^{opt}$$

Taking account of the constraints Σ_{i∈R}_{ᵣ}uᵢ^{j}=1 and Σ_{i∉R}_{ᵣ}uᵢ¹=0, the output physical quantity Y may be reformulated in the following manner:

$$Y = {\sum }_{i ∈ {R}_{r}} {\overline{y}}_{i} \times {u}_{i}^{opt}$$

One finds once again the expression of the output physical quantity of the method 100 according to a first aspect of the invention in which only the range Rᵣ has been taken into account.

The method 200 according to a second aspect of the invention may for example be used to control a system such as illustrated in FIG. 6. As a reminder, the system in question is composed of photovoltaic panels PV, a storage device ESS and a network grid GRID. In this example, the system is modelled over a horizon of 24 h with a time step of 1 minute and the storage is modelled using the non-convex function PDC=g(PAC) (but convex by range, the number of ranges here being equal to two). In this model, the storage system ESS is represented by a non-linear and non-convex energy losses function which may be linearized piecewise. It is thus possible to compare the method 200 according to a second aspect of the invention with the SOS2 method of the prior art. Table 2 hereafter presents the comparative results between these two methods. It may be observed that, for the same solution, the resolution time passes from 2 h for a method according to the prior art to 13 seconds for a method 200 according to a second aspect of the invention.

TABLE 2

| | | Method (200) according to |
|---|---|---|
| | | a first aspect of the |
| | SOS2 method | invention |
| Number of continuous | 12960 | 12960 |
| variables | | |
| Number of discrete | 10080 | 1440 (making it possible |
| variables | | to identify the selected |
| | | range) |
| Time to compute the | 2 h | 13 s |
| optimal solution | | |

The reduction in the necessary computing power and thus the rapidity of implementation of a method 100, 200 according to a first or a second aspect of the invention makes the use of the latter particularly suited to the control of a system, for example an electrical system.

To do so, a third aspect of the invention relates to a method 300 for controlling a system, for example an electrical system such as illustrated in FIG. 6.

The method according to a third aspect of the invention comprises a step of determining the temporal evolution of the system, the output physical quantity of the system during this determination being determined using a method according to a first aspect of the invention or a second aspect of the invention. As detailed in the introduction, during this step, the evolution of the system over a horizon and for a given time step is going to be computed. The use of a non-linear model being much too costly in time, it is desirable to linearize the model in order to perform the computations. To do so, the method according to a third aspect of the invention uses a method according to a first aspect of the invention when the model is convex and a method according to a second aspect of the invention when the model is not convex (but only convex by range).

It is interesting to note that the use of a method according to a first or a second aspect of the invention makes it possible to carry out a very reactive control. Indeed, before generating a set point, it is desirable to wait for the computations of temporal evolution of the system to have terminated in order to ensure that the set point is compatible with the desired trajectory or in order to correct an erroneous trajectory. Yet, as shown in tables 1 and 2, with a method according to the prior art, a set point could only be emitted every two hours in the example chosen, which is too long. With a method according to a first or a second aspect of the invention, for a same precision in the computations, the necessary time is no more than several seconds (or even less if the model is convex), which is compatible with control in real time of an installation.

Once the temporal evolution of the system has been calculated, it is possible to determine a set point making it possible to maintain the trajectory or, conversely, to correct the latter. To do so, the control method according to a third aspect of the invention comprises a step of determining a set point, the set point being determined as a function of the temporal evolution of the system determined previously.

It will be appreciated that the method and system described herein provide a technical solution to the technical problem currently faced by the skilled artisan for managing a multi-energy networked system efficiently. As explained previously, current management methods and systems have the major drawback of resorting to a high number of binary variables, which makes the computations relatively complex and thus compatible with difficulty with the control in real time of an installation for which it is necessary to compute a set point in a relatively short time (depending on the type of installation).

An aspect of the method described herein is specifically tied to the practical application of controlling complex installations such as electrical installations. The method recited in the claims provide the technical features and steps that permit one to determine the output physical quantity of a system from an input physical quantity and a non-linear model of the system and solve the technical problem identified above.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium (e.g. a memory) is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable processor, digital signal processor (DSP), a computer, a system on a chip, or multiple ones, or combinations, of the foregoing. The apparatus can include special purpose logic circuitry, e.g., an FPGA (field programmable gate array) or an ASIC (application-specific integrated circuit).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The present invention has been described and illustrated in the present detailed description and in the figures of the appended drawings, in possible embodiments. The present invention is not however limited to the embodiments described. Other alternatives and embodiments may be deduced and implemented by those skilled in the art on reading the present description and the appended drawings.

In the claims, the term “includes” or “comprises” does not exclude other elements or other steps. A single processor or several other units may be used to implement the invention. The different characteristics described and/or claimed may be beneficially combined. Their presence in the description or in the different dependent claims do not exclude this possibility. The reference signs cannot be understood as limiting the scope of the invention.

1. A method for determining an output physical quantity Y of a system from an input physical quantity X of the system and a non-linear and convex physical model of the system associating with an input physical quantity x̅ᵢ an output physical quantity y̅ᵢ, the method comprising:
a step of determining, using the non-linear physical model, a plurality of operating points M̅ᵢ of coordinates (x̅ᵢ, y̅ᵢ) with i ∈ [1, N];
a step of determining an optimal vector U^{opt} among a plurality of vectors U^{j}, said vectors U^{j} comprising N coordinates uᵢ^{j} ∈ [0,1], the constraints on said coordinates being:
$$\{ \begin{matrix}X = {\sum }_{i = 1}^{N} {\overline{x}}_{i} \times {u}_{i}^{j} , ∀ j \\ {\sum }_{i = 1}^{N} {u}_{i}^{j} = 1 , ∀ j\end{matrix}$$
the optimal vector U^{opt} being associated with the following lowest objective function:
$$M \times {\sum }_{i = 1}^{N} {\overline{y}}_{i} \times {u}_{i}^{j}$$
where M is a weighting coefficient strictly greater than zero;
a step of determining the output physical quantity Y given by:
$$Y = {\sum }_{i = 1}^{N} {\overline{y}}_{i} \times {u}_{i}^{opt}$$

2. A method for determining the output physical quantity Y of a system from an input physical quantity X of said system and a non-linear physical model of said system associating with an input physical quantity x̅ᵢ an output physical quantity y̅ᵢ, the method comprising:
a step of determining, using the non-linear physical model, a plurality of operating points M̅ᵢ of coordinates (x̅ᵢ, y̅ᵢ) with i ∈ [1, N];
a step of determining a plurality of ranges Rₖ of values of x̅ᵢ, the physical model being convex over each of the ranges Rₖ of the plurality of ranges Rₖ thus determined;
a step of determining the range Rᵣ among the plurality of ranges Rₖ such that X ∈ Rᵣ;
a step of determining an optimal vector U^{opt} among a plurality of vectors U^{j}, said vectors U^{j} comprising N coordinates uᵢ^{j} ∈ [0,1], the constraints on said coordinates being:
$$\{ \begin{matrix}X = {\sum }_{{R}_{k}} {\sum }_{i ∈ {R}_{r}} {\overline{x}}_{i} \times {u}_{i}^{j} , ∀ j \\ {\sum }_{i ∈ {R}_{r}} {u}_{i}^{j} = 1 , ∀ j \\ {\sum }_{i ∉ {R}_{r}} {u}_{i}^{j} = 0 , ∀ j\end{matrix}$$
the optimal vector U^{opt} being associated with the following lowest objective function:
$$M \times {\sum }_{{R}_{k}} {\sum }_{i ∈ {R}_{r}} {\overline{y}}_{i} \times {u}_{i}^{j}$$
where M is a weighting coefficient strictly greater than zero;
a step of determining the output physical quantity Y given by:
$$Y = {\sum }_{{R}_{k}} {\sum }_{i ∈ {R}_{r}} {\overline{y}}_{i} \times {u}_{i}^{opt}$$

3. The method according to claim 1, comprising a step of acquiring a plurality of input and output physical quantities of the system so as to determine the physical model of said system.

4. A method for controlling a characterised system comprising:
a step of determining the temporal evolution of the system, the output physical quantity of the system during this determination being determined using a method according to claim 1;
a step of determining a set point, said set point being determined as a function of the temporal evolution of the system determined previously.

5. A computer program comprising instructions which, when the program is executed by a computer, lead said computer to implement a method according to claim 1.

6. A non-transitory computer readable data support, on which is recorded the computer programme according to claim 5.
